(19) United States
(12) Patent Application Publication
(10) Pub. No.: US 2025/0309388 A1
(43) Pub. Date: Oct. 2, 2025

(54) PEELING METHOD AND PEELING DEVICE FOR POSITIVE ELECTRODE CURRENT COLLECTOR AND POSITIVE ELECTRODE MIXTURE MATERIAL

(71) Applicants: HONDA MOTOR CO., LTD., TOKYO (JP); DKK Co., Ltd., Tokyo (JP)

(72) Inventors: Takayuki SAKATA, WAKO-SHI (JP); Mitsumasa SORAZAWA, WAKO-SHI (JP); Yushi FUJINAGA, WAKO-SHI (JP); Satoru TAKAHASHI, WAKO-SHi (JP); Hiroyuki KAI, TOKYO (JP)

(21) Appl. No.: 19/000,874

(22) Filed: Dec. 24, 2024

(30) Foreign Application Priority Data
Mar. 28, 2024 (JP) 2024-054883

(51) Int. Cl. H01M 10/54

(52) U.S. Cl. CPC H01M 10/54

(57) ABSTRACT

In a peeling method for a positive electrode current collector and a positive electrode mixture material for peeling the positive electrode mixture material from the positive electrode current collector, induction heating is effected in the positive electrode current collector to dissolve or vaporize a binder of the positive electrode mixture material bonded to the positive electrode current collector.

### INCORPORATION BY REFERENCE

The present application claims priority under 35 U.S.C. § 119 to Japanese Patent Application No. 2024-054883 filed on Mar. 28, 2024. The content of the application is incorporated herein by reference in its entirety.

### BACKGROUND OF THE INVENTION

### Field of the Invention

The present invention relates to a peeling method and a peeling device for a positive electrode current collector and a positive electrode mixture material.

### Description of the Related Art

Some lithium ion batteries and all-solid-state batteries include a stacked electrode in which positive electrode plates and negative electrode plates are stacked via separators. For the positive electrode mixture material of this type of battery, a nickel, cobalt, and manganese-based ternary positive electrode material (NCM) is used. When the battery is discarded, it is preferable to recover valuable metals, such as NCM. The positive electrode mixture material is bonded to an aluminum material as a positive electrode current collector by means of a binder that the positive electrode mixture material includes.

Conventionally, a technique has been known in which a cut piece of a positive electrode plate composed of an aluminum material and a positive electrode mixture material is placed in water where a shock wave is generated through electric pulse discharge so that different materials are separated while crushing the positive electrode plate (see, for example, Japanese Patent Laid-Open No. 2023-086495).

However, when the aluminum material and the positive electrode mixture material are separated in such a method in which the aluminum material as the positive electrode current collector is crushed, contamination of aluminum increases at a valuable metal recovering stage.

The present invention has been made in view of the aforementioned circumstances, and has an object of providing a peeling method and a peeling device capable of effectively recovering a positive electrode mixture material.

### SUMMARY OF THE INVENTION

A peeling method for a positive electrode current collector and a positive electrode mixture material for peeling the positive electrode mixture material from the positive electrode current collector of the present disclosure, the peeling method including effecting induction heating in the positive electrode current collector to dissolve or vaporize a binder of the positive electrode mixture material bonded to the positive electrode current collector.

Further, a peeling device for a positive electrode current collector and a positive electrode mixture material for peeling the positive electrode mixture material from the positive electrode current collector of the present disclosure, the peeling device including: a container where a stacked body of the positive electrode current collector and the positive electrode mixture material is placed; and a magnetic field generating portion disposed outside the container, the magnetic field generating portion being configured to effect induction heating in the positive electrode current collector.

It is possible to recover a positive electrode mixture material while suppressing crushing of an aluminum material.

### BRIEF DESCRIPTION OF THE DRAWINGS

FIG. 1 is a view schematically showing a target battery to which a processing method for a battery of the present invention can be applied;

FIG. 2 is a cross-sectional view schematically showing a peeling device for a positive electrode current collector and a positive electrode mixture material;

FIG. 3 is a schematic view for explaining a magnetic field generating portion and a magnetic field;

FIG. 4 is a cross-sectional view of A-A′ of FIG. 3;

FIG. 5 is a flowchart showing procedures of a peeling method for a positive electrode current collector and a positive electrode mixture material;

FIG. 6 is a schematic view for explaining a positive electrode plate in a state having been subjected to induction heating;

FIG. 7 is a schematic view for explaining the positive electrode plate in a state having been subjected to induction heating of Embodiment 2; and

FIG. 8 is a schematic view for explaining a magnetic field generating portion and a magnetic field of Embodiment 3.

### DETAILED DESCRIPTION OF THE INVENTION

### Embodiments 1

Hereinafter, with reference to the drawings, embodiments of the present invention will be described.

### 1. Configuration of Target Battery

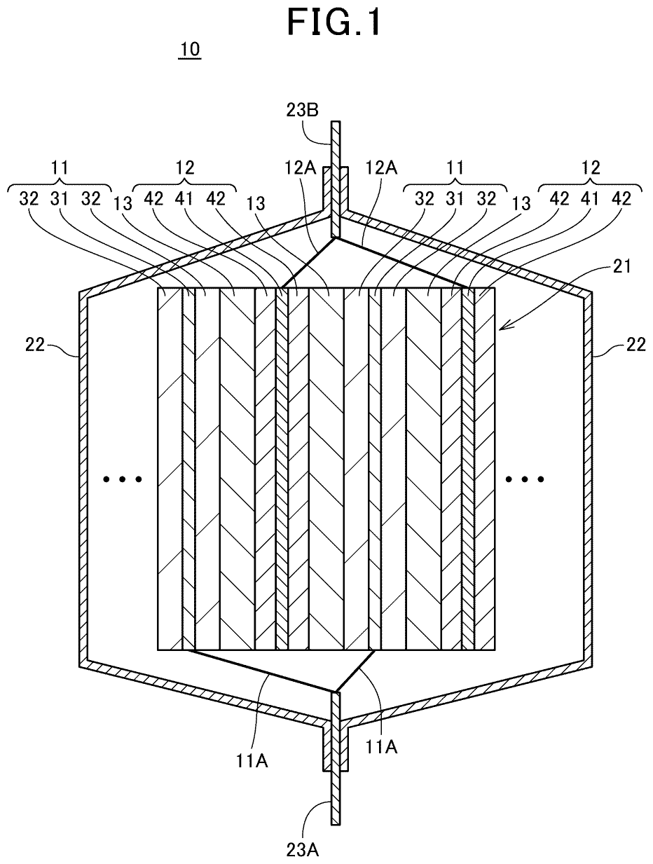

FIG. 1 is a view showing the configuration of a target battery 10 as an example of a target battery to which the present disclosure is applied, and schematically shows a cross-section of the target battery 10. The target battery 10 is a secondary battery capable of charging and discharging. The target battery 10 described in the present embodiment is a laminated battery in which a battery material is enclosed in a laminate material 22, and is generally in a flat plate shape. The target battery 10 may be referred to as a pouch battery, a laminated battery cell, a pouch battery cell, a lithium ion battery cell, a battery module, and the like.

The target battery 10 is a secondary battery that is a so-called lithium ion battery, and has been drawing attention as a power storage device having a high energy density. Examples of a positive electrode active material of the lithium ion battery include lithium cobaltate, lithium nickelate, lithium manganese, and lithium iron phosphate. Further, examples of the positive electrode active material include a ternary positive electrode material (NCM) containing nickel, cobalt, and manganese. For a negative electrode active material of the lithium ion battery, for example, a carbon-based material is used. Furthermore, an all-solid-state battery using a solid electrolyte as an electrolyte of the lithium ion battery has been known.

Nickel, cobalt, and manganese used as the positive electrode active material of the lithium ion battery, the all-solid-state battery, and the like are known as valuable metals and are required to be recovered from used batteries.

As shown in FIG. 1, the target battery 10 has a configuration in which a stacked electrode 21 is accommodated in the laminate material 22. The laminate material 22 is, for example, a laminate film having a metal material, such as aluminum alloy and stainless steel, as a base material. The laminate material 22 functions as a sealing body that seals an exterior body of the target battery 10 and the stacked electrode 21.

The target battery 10 of the present embodiment is in a flat plate shape with two laminate materials 22 bonded together, and a pair of current collecting tabs 23A, 23B for taking power out of the target battery 10 extend through the exterior body and are exposed from end portions of the target battery 10.

The stacked electrode 21 is a multi-layer body in which positive electrode plates 11 and negative electrode plates 12 are stacked and a separator 13 is disposed between each of the positive electrode plates 11 and each of the negative electrode plates 12. The separator 13 is disposed between the positive electrode plate 11 and the negative electrode plate 12 and prevents a short circuit between the positive electrode plate 11 and the negative electrode plate 12.

The positive electrode plates 11 and the negative electrode plates 12 are alternately disposed, and one positive electrode plate 11 and one negative electrode plate 12 opposing each other form one pair of electrode plates. A plurality of pairs of electrode plates are stacked so as to form the stacked electrode 21.

The positive electrode plate 11 includes a positive electrode current collector 31 in a rectangular plate shape, and a positive electrode mixture material 32 is provided on both sides of the positive electrode current collector 31. The positive electrode current collector 31 is an aluminum material formed in a foil or a plate shape. The positive electrode mixture material 32 includes, for example, a positive electrode active material, a conductive material, a conductive agent, and a binder. The positive electrode plate 11 includes a positive electrode terminal 11A extending from an end portion of the positive electrode plate 11. The positive electrode terminals 11A extending from a plurality of positive electrode plates 11 that form the stacked electrode 21 are each connected to the current collecting tab 23A.

The negative electrode plate 12 includes a negative electrode current collector 41 in a rectangular plate shape. In the negative electrode current collector 41, on a side opposing the positive electrode plate 11, a negative electrode mixture material 42 is provided. For the negative electrode current collector 41, for example, copper foil is used. The negative electrode plate 12 includes a negative electrode terminal 12A extending from an end portion of the negative electrode plate 12. The negative electrode terminals 12A extending from a plurality of negative electrode plates 12 that form the stacked electrode 21 are each connected to the current collecting tab 23B.

The current collecting tabs 23A, 23B are formed of a metal material, such as copper or aluminum, in a thin plate shape, and pass through between the two laminate materials 22 and are exposed to the outside.

When the target battery 10 is a lithium ion battery, the inside of the laminate material 22 is filled with a liquid or a gelatinous electrolyte solution. The electrolyte solution includes, for example, an electrolyte, a solvent, and an additive. Examples of the electrolyte include lithium salt, such as lithium hexafluorophosphate (LiPF6). Examples of the solvent and the additive include carbonate ester, such as ethylene carbonate, dimethyl carbonate, diethyl carbonate, and vinylene carbonate. These are examples and the electrolyte, the solvent, and the additive can be appropriately selected and changed.

When the target battery 10 is an all-solid-state battery, a solid electrolyte is disposed inside the laminate material 22. As the solid electrolyte, an oxide-based electrolyte and a sulfide-based electrolyte have been known, but the all-solid-state batteries using other materials can also be the target to which the present disclosure is applied. The solid electrolyte of the all-solid-state battery is disposed, for example, between the positive electrode plate 11 and the negative electrode plate 12, in place of the separator 13. In this case, the solid electrolyte also has a function of preventing a short circuit between the positive electrode plate 11 and the negative electrode plate 12, in addition to a function as an electrolyte.

### 2. Peeling Device

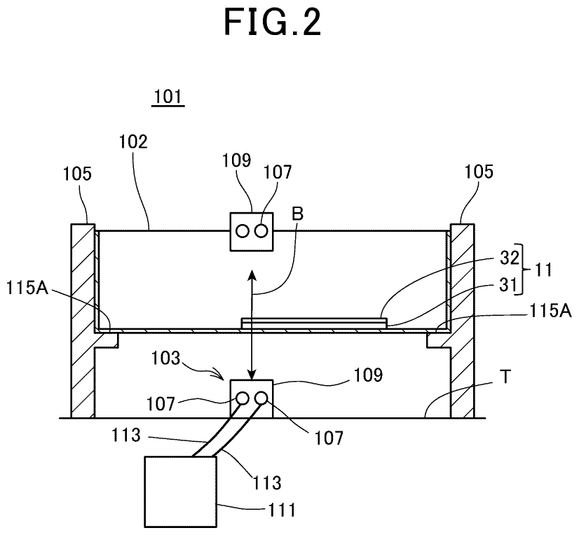

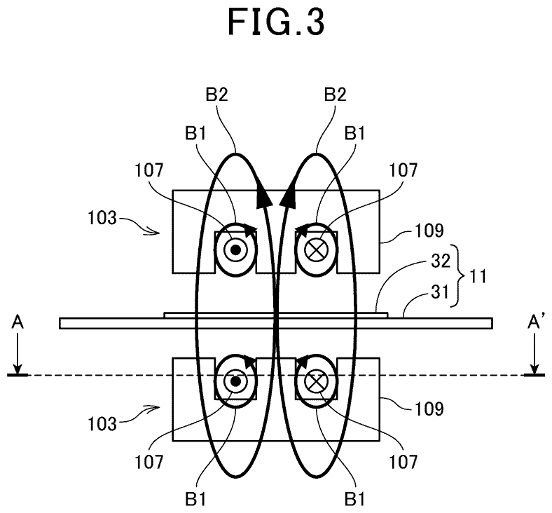

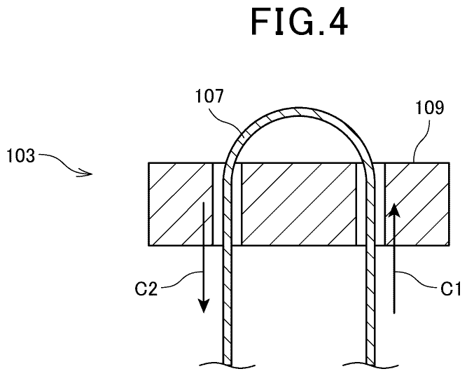

FIG. 2 is a cross-sectional view schematically showing a peeling device 101. The peeling device 101 is a device that peels the positive electrode mixture material 32 from an upper surface of the positive electrode current collector 31. FIG. 3 is a schematic view for explaining a magnetic field generating portion 103 and a magnetic field. FIG. 4 is a cross-sectional view of A-A′ of FIG. 3.

The peeling device 101 includes a device main body 105. The device main body 105 is placed on a workbench T. The device main body 105 includes a support portion 115A halfway in the height direction. A container 102 is placed on the support portion 115A and the container 102 is filled with a liquid, such as water. The device main body 105 and the container 102 are made of glass. Note that the material and the shape of the device main body 105 and the container 102 are not particularly limited.

In a space below the container 102, the magnetic field generating portion 103 is disposed. The magnetic field generating portion 103 includes an iron core 109. The iron core 109 includes an electric wire 107, and the electric wire 107 is connected to a power source device 111 via wiring 113. The electric wire 107 is routed in a groove (see FIG. 3 and FIG. 4) formed in the iron core 109.

Note that the iron core 109 is an example of a magnetic body. The magnetic body is a member for intensifying the magnetic field and rectifying the direction of the magnetic field.

Further, the magnetic field generating portion 103 is also disposed above the container 102. Though the illustration is omitted, the magnetic field generating portion 103 below and the magnetic field generating portion 103 above are electrically connected to each other. The magnetic field generating portions 103 are supported by a support portion (for example, a clamp) which is not shown.

The power source device 111 includes a transformer to generate alternating current. Note that the power source device 111 may generate direct current.

When the alternating current is made to flow by the power source device 111, a magnetic field B is generated from the magnetic field generating portion 103 in the vertical direction. The magnetic field B generated from the magnetic field generating portion 103 acts in the vertical direction as denoted by an arrow of FIG. 2. The direction of the magnetic field B is switched between upward and downward directions depending on the direction of the alternating current.

More specifically, as shown in FIG. 3, with the current flowing through the electric wire 107, a magnetic field B1 is generated in accordance with a so-called Ampere's law. The magnetic fields B1 generated respectively from four electric wires 107 are layered so that a magnetic field B2 is generated. The magnetic field B2 is generated so as to extend through the magnetic field generating portions 103 above and below and further, becomes the magnetic field B extending in the up-down direction as shown in FIG. 2.

As shown in FIG. 4, for one magnetic field generating portion 103, the electric wire 107 is routed such that currents C1, C2 flow in parallel and in directions reverse to each other. In this manner, at the center of the opposing electric wires 107 in one magnetic field generating portion 103, the magnetic field B is intensified. Further, since the magnetic field generating portions 103 are disposed above and below in a superposed manner, the magnetic field B is further intensified.

The iron core 109 functions to rectify and intensify the magnetic field at the center of the opposing electric wires 107 in one magnetic field generating portion 103.

Note that the magnetic field generating portion 103 above may be simply replaced only with the iron core 109. Even when one of the magnetic field generating portions 103 is the magnetic field generating portion 103 and the other is the iron core 109, the magnetic field B shown in FIG. 2 can still be intensified.

In this manner, since the strength and the direction of the magnetic field can be appropriately set in peeling the positive electrode mixture material 32 and the positive electrode current collector 31, the peeling efficiency can be improved.

On a bottom of the container 102, the positive electrode plate 11 as a peeling target is placed. Note that the positive electrode plate 11 is in a stated of being separated from the aforementioned target battery 10.

### 3. Peeling Method

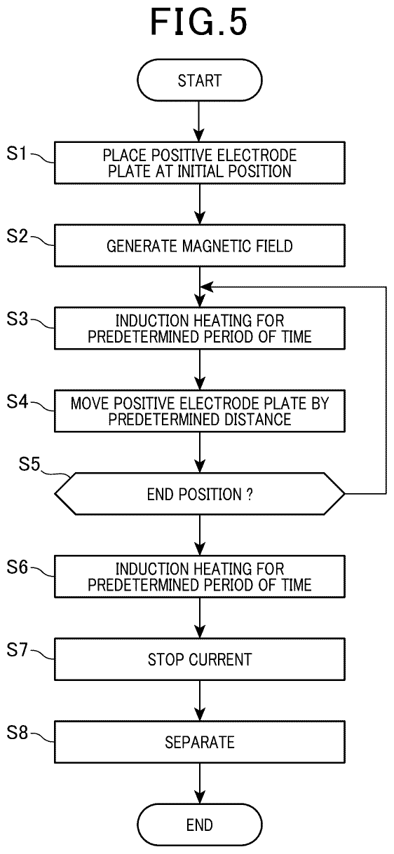

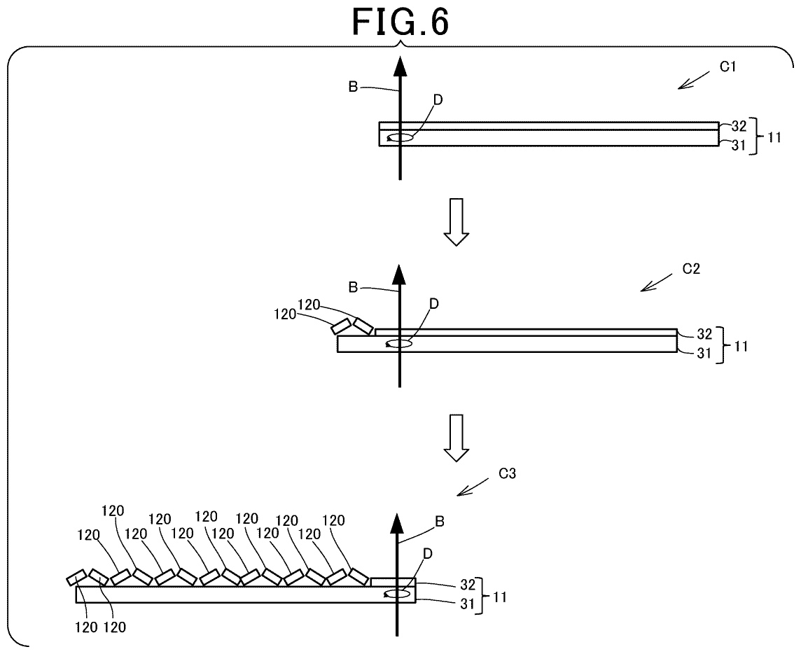

Next, with reference to FIG. 5 and FIG. 6, a peeling method for the positive electrode mixture material 32 and the positive electrode current collector 31 will be described. FIG. 5 is a flowchart showing procedures of the peeling method.

First, the positive electrode plate 11 is placed at an initial position of the bottom of the container 102 (step S1). The initial position is, as shown in FIG. 6, a position where the magnetic field B generated by the magnetic field generating portion 103 extends through one end in the longitudinal direction of the positive electrode plate 11.

Next, the magnetic field B is generated by the magnetic field generating portion 103 (step S2). In step S2, as shown in a condition C1 of FIG. 6, when the magnetic field B is generated, an eddy current D flows through the positive electrode current collector 31 centered on the magnetic field B, triggering induction heating to thereby increase the temperature of the positive electrode current collector 31. The positive electrode mixture material 32 has a low electrical conductivity and is thus less likely to be subjected to induction heating.

Then, over a predetermined period of time, the induction heating is continued (step S3).

Thereafter, the positive electrode plate 11 is moved only by a predetermined distance such that a site subjected to the induction heating is displaced to the right side (step S4). When the site subjected to the induction heating is displaced, the device main body 105 placed on the workbench T may be moved or the magnetic field generating portion 103 may be moved.

In the condition C1 of FIG. 6, when the induction heating for a predetermined period of time is continued, in the site that was subjected to the induction heating, the positive electrode mixture material 32 of the positive electrode current collector 31 is peeled off so that a peeled piece 120 is generated as shown in a condition C2 of FIG. 6. The binder included in the positive electrode mixture material 32 vaporizes due to heat so that the positive electrode mixture material 32 and the positive electrode current collector 31 are peeled off from each other.

The predetermined period of time is preset at a period of time to the extent that the positive electrode mixture material 32 can be effectively peeled off from the positive electrode current collector 31 by dissolving or vaporizing the binder of the positive electrode mixture material 32, and the positive electrode current collector 31 is not crushed.

The induction heating for a predetermined period of time is repeatedly continued while displacing the position of the positive electrode plate 11 until a condition C3 of FIG. 6 is reached, and each time, the positive electrode plate 11 is subjected to the induction heating due to the eddy current D generated by the magnetic field B. The predetermined distance is preset so as to avoid a portion where the peeled piece 120 was generated and a next portion to be subjected to the induction heating from overlapping each other.

When the positive electrode plate 11 has not yet been moved to an end position (step S5: NO), the operations of steps S3, S4 are repeated. The end position is a position where the magnetic field B generated by the magnetic field generating portion 103 extends through the other end in the longitudinal direction of the positive electrode plate 11.

When the operations of steps S3, S4 are repeated, as shown in the condition C3 of FIG. 6, the positive electrode mixture material 32 is peeled from the left toward the right.

When the positive electrode plate 11 has been moved to the end position (step S5: YES), the induction heating for the predetermined period of time is continued (step S6). In this manner, over the entire longitudinal direction of the positive electrode plate 11, the binder on the interface between the positive electrode mixture material 32 and the positive electrode current collector 31 vaporizes, so that the peeled pieces 120 are generated.

Next, the current supply from the power source device 111 is stopped and generation of the magnetic field B by the magnetic field generating portion 103 is stopped (step S7).

Finally, contents of the container 102 are sifted through a sieve with a mesh of several millimeters to separate the positive electrode mixture material 32 and the positive electrode current collector 31 from each other (step S8). The positive electrode mixture material 32 turns into the peeled pieces 120 and is peeled off from the positive electrode current collector 31, but some portions still remain attached in some cases. In that case, the remaining positive electrode mixture material 32 is peeled off with tweezers or the like.

With the operations above, the positive electrode mixture material 32 can be peeled off without crushing the aluminum material that composes the positive electrode current collector 31.

Note that the frequency of the alternating current is set to be short and the waveform is set to be a pulse waveform. With this and the cooling effect of water filling the container 102, a phenomenon, in which the positive electrode current collector 31 is crushed due to the eddy current D flowing for a long period of time and the positive electrode current collector 31 is overheated, can be suppressed. If the positive electrode current collector 31 is crushed, aluminum contamination could increase in the recovery of the positive electrode mixture material 32. Further, since the induction heating is effected by the eddy current flowing through the positive electrode current collector 31, if the area where the eddy current flows is reduced due to crushing of the positive electrode current collector 31, there is a possibility that the induction heating is not sufficiently performed.

In the present embodiment, since a pulse current is made to flow through the magnetic field generating portion 103 by the power source device 111, aluminum contamination is suppressed and the binder can be efficiently vaporized through the induction heating.

Note that an output time and an output value of the pulse current can be appropriately controlled.

### Embodiment 2

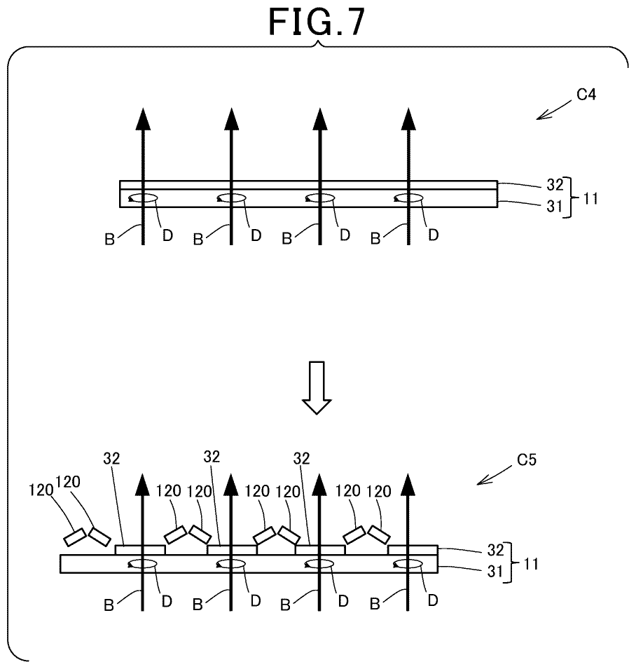

Next, using FIG. 7, Embodiment 2 will be described. FIG. 7 is a schematic view showing the positive electrode plate 11 subjected to induction heating of Embodiment 2. In FIG. 7, for the same components as those of FIG. 6, the same reference signs are assigned and the descriptions will be omitted.

The peeling device 101 of Embodiment 2 includes a plurality of magnetic field generating portions 103 shown in FIG. 2 with a predetermined distance in the lateral direction.

As shown in a condition C4 of FIG. 7, the magnetic fields B are simultaneously generated in the positive electrode plate 11 placed at an initial position, by the plurality of magnetic field generating portions 103. The distance between the magnetic fields B, that is, the distance between the plurality of magnetic field generating portions 103 is set such that the plurality of magnetic field generating portions 103 is apart from each other to the extent that the adjacent other magnetic fields B are not affected. The eddy current D is generated from each magnetic field B.

By simultaneously effecting the induction heating of the positive electrode current collector 31 at a plurality of sites, the peeled pieces 120 are generated at each site.

Next, as shown in a condition C5 of FIG. 7, the positive electrode plate 11 is displaced by a predetermined distance, and the induction heating is effected at a site where the peeled piece 120 is not generated.

In this manner, by effecting the induction heating at a plurality of sites, peeling of the positive electrode current collector 31 and the positive electrode mixture material 32 can be performed in a short period of time.

### Embodiment 3

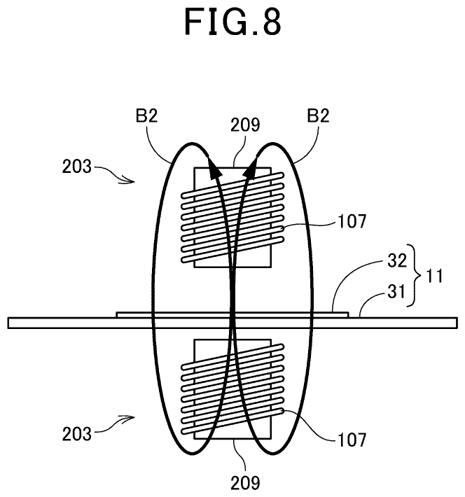

Next, using FIG. 8, Embodiment 3 will be described. FIG. 8 is a schematic view for explaining a magnetic field generating portion 203 and the magnetic field B2 of Embodiment 3. For the same components as those of FIG. 3, the same reference signs are assigned and the descriptions will be omitted.

The magnetic field generating portion 203 of Embodiment 3 includes the electric wire 107 wound around an iron core 209. The magnetic field generating portion 203 functions as a rod-like electromagnet and causes the magnetic field B2 to be generated. In this manner, the magnetic field B2 can be further intensified.

### CONFIGURATIONS SUPPORTED BY THE AFOREMENTIONED EMBODIMENTS

The aforementioned embodiments support the following configurations.

(Configuration 1) A peeling method for a positive electrode current collector and a positive electrode mixture material for peeling the positive electrode mixture material from the positive electrode current collector, the peeling method including: effecting induction heating in the positive electrode current collector to dissolve or vaporize a binder of the positive electrode mixture material bonded to the positive electrode current collector.

According to Configuration 1, since the positive electrode current collector has a greater electric conductivity than the positive electrode mixture material and is thus more likely to cause an induction current to flow, only the positive electrode current collector can be selectively subjected to induction heating. Therefore, the positive electrode mixture material can be recovered while suppressing crushing of the positive electrode current collector.

(Configuration 2) The peeling method for a positive electrode current collector and a positive electrode mixture material according to Configuration 1, in which a pulse current is made to flow through a magnetic field generating portion that effects the induction heating.

According to Configuration 2, an eddy current generated in an aluminum material does not flow for a long period of time due to the magnetic field generated by the magnetic field generating portion. Therefore, crushing of the aluminum material due to overheating can be suppressed.

(Configuration 3) The peeling method according to Configuration 1 or 2, in which a site where the induction heating is effected is moved.

Configuration 3 is efficient in that the positive electrode mixture material can be continuously peeled.

(Configuration 4) The peeling method for a positive electrode current collector and a positive electrode mixture material according to Configuration 1 or 2, in which the induction heating is effected at a plurality of sites in the positive electrode current collector.

Configuration 4 is efficient in that the positive electrode mixture material can be simultaneously peeled at a plurality of sites.

(Configuration 5) A peeling device for a positive electrode current collector and a positive electrode mixture material for peeling the positive electrode mixture material from the positive electrode current collector, the peeling device including: a container where a stacked body of the positive electrode current collector and the positive electrode mixture material is placed; and a magnetic field generating portion disposed outside the container, the magnetic field generating portion being configured to effect induction heating in the positive electrode current collector.

According to Configuration 5, the same function and effect as those of Configuration 1 are produced.

(Configuration 6) The peeling device for a positive electrode current collector and a positive electrode mixture material according to Configuration 5, in which the magnetic field generating portion is disposed on one side and the magnetic field generating portion or a magnetic body is disposed on the other side across the positive electrode current collector.

According to Configuration 6, the magnetic field can be further intensified.

### REFERENCE SIGNS LIST

10 target battery
11 positive electrode plate
12 negative electrode plate
13 separator
21 stacked electrode
22 laminate material
23A, 23B current collecting tab
31 positive electrode current collector
32 positive electrode mixture material
41 negative electrode current collector
42 negative electrode mixture material
101 peeling device
103, 203 magnetic field generating portion
105 device main body
107 electric wire
109, 209 iron core (magnetic body)
111 power source device
113 wiring
115 support mount
115A support portion
120 peeled piece
B magnetic field
C1, C2, C3, C4, C5 condition
D eddy current

1. A peeling method for a positive electrode current collector and a positive electrode mixture material for peeling the positive electrode mixture material from the positive electrode current collector, the peeling method comprising:
effecting induction heating in the positive electrode current collector to dissolve or vaporize a binder of the positive electrode mixture material bonded to the positive electrode current collector.

2. The peeling method for a positive electrode current collector and a positive electrode mixture material according to claim 1, wherein a pulse current is made to flow through a magnetic field generating portion that effects the induction heating.

3. The peeling method for a positive electrode current collector and a positive electrode mixture material according to claim 1, wherein a site where the induction heating is effected is moved.

4. The peeling method for a positive electrode current collector and a positive electrode mixture material according to claim 1, wherein the induction heating is effected at a plurality of sites in the positive electrode current collector.

5. A peeling device for a positive electrode current collector and a positive electrode mixture material for peeling the positive electrode mixture material from the positive electrode current collector, the peeling device comprising:
a container where a stacked body of the positive electrode current collector and the positive electrode mixture material is placed; and
a magnetic field generating portion disposed outside the container, the magnetic field generating portion being configured to effect induction heating in the positive electrode current collector.

6. The peeling device for a positive electrode current collector and a positive electrode mixture material according to claim 5, wherein the magnetic field generating portion is disposed on one side and the magnetic field generating portion or a magnetic body is disposed on another side across the positive electrode current collector.
